(19) United States
(12) Patent Application Publication
(10) Pub. No.: US 2026/0030511 A1
(43) Pub. Date: Jan. 29, 2026

(54) DATA-FREE KNOWLEDGE AMALGAMATION FOR TEXT CLASSIFICATION

(71) Applicant: INTERNATIONAL BUSINESS MACHINES CORPORATION, ARMONK, NY (US)

(72) Inventors: Prashanth Vijayaraghavan, Fremont, CA (US); EHSAN DEGAN, Rancho Santa Margarita, CA (US); HONGZHI WANG, Santa Bruno, CA (US); Luyao Shi, New Haven, CT (US); Tyler Baldwin, Ann Arbor, MI (US); David James Beymer, San Jose, CA (US)

(21) Appl. No.: 18/781,060

(22) Filed: Jul. 23, 2024

(51) Int. Cl. G06N 3/096; G06N 3/045

(52) U.S. Cl. CPC G06N 3/096; G06N 3/045

(57) ABSTRACT

A method, computer system, and a computer program product for data-free knowledge amalgamation are provided. Multiple pre-trained teacher machine learning models are obtained. Each is trained on a respective different set of training data. Pseudo-data samples that mimic original training data of the teacher models are generated. A block-wise amalgamation with a self-regulative strategy to integrate knowledge from the multiple teacher models is implemented by inputting the pseudo-data samples into the teacher models and into a student machine learning model. The implementing also includes aligning intermediate representations of the student model with a unified representation capturing relevant features from the teacher models.

### BACKGROUND

The present invention relates generally to the fields of machine learning model, training machine learning models, and text classification performed via machine learning models.

### SUMMARY

According to one exemplary embodiment, a computer-implemented method is provided. Multiple pre-trained teacher machine learning models are obtained. Each of the teacher models was trained on a respective different set of training data. Pseudo-data samples that mimic the respective training data of the teacher models are generated. A block-wise amalgamation with a self-regulative strategy to integrate knowledge from the multiple teacher models is implemented by inputting the pseudo-data samples into the teacher models and into a student machine learning model. The implementing also includes aligning intermediate representations of the student model with a unified representation capturing relevant features from the teacher models. A computer system and computer program product corresponding to the above method are also disclosed herein.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description.

FIG. 1 illustrates a framework for data-free knowledge amalgamation for text classification according to at least one embodiment.

FIG. 2 illustrates details of a steerable data generator according to at least one embodiment which is part of the framework for data-free knowledge amalgamation for text classification that was shown in FIG. 1.

FIG. 3 illustrates details of a block-wise amalgamation module according to at least one embodiment which is part of the framework for data-free knowledge amalgamation for text classification that was shown in FIG. 1.

FIG. 4 illustrates a Graph 1 that is a bar chart showing how use of different techniques to determine the OOD score affects the overall performance of the model.

FIG. 5 illustrates a Graph 2 that shows for two different datasets how modifying λ values in the loss function affects model performance.

FIG. 6 illustrates a networked computer environment in which code for the data-free knowledge amalgamation for text classification is performed according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

According to one exemplary embodiment, a computer-implemented method is provided. Multiple pre-trained teacher machine learning models are obtained. Each of the teacher models was trained on a respective different set of training data. Pseudo-data samples that mimic the respective training data of the teacher models are generated. A block-wise amalgamation with a self-regulative strategy to integrate knowledge from the multiple teacher models is implemented by inputting the pseudo-data samples into the teacher models and into a student machine learning model. The implementing includes aligning intermediate representations of the student model with a unified representation capturing relevant features from the teacher models.

In this manner, a student machine learning model may take advantage of the knowledge of teacher machine learning models even without having access to original training data that was used to train the teacher models.

According to one enhancement, a computer-implemented method further includes the student model being trained by optimizing its parameters to enhance its performance, based on comparing probability distributions of predictions made by the teacher models to probability distributions of predictions made by the student model for the pseudo-data samples. In this manner, a student machine learning model may receive training and assistance from multiple teacher models that were trained with different sets of training data some of which may contain label sets that have no overlap or partial overlap with each other.

According to one enhancement, the above-mentioned optimizing in a computer-implemented method further includes minimizing a combined loss that includes a block-wise knowledge transfer loss and Kullback-Leibler (KL) divergence between the predictions of the teacher models and of the student model for the pseudo-data samples. In this manner, a student machine learning model may receive training and assistance from multiple teacher models that were trained with training data that included label sets that may have no overlap or partial overlap.

According to one enhancement, the block-wise knowledge transfer loss of a method is calculated as an L2-normalized distance between a projected block-level representation of the student model and a corresponding amalgamated embedding of the teacher models. In this manner, artificial intelligence techniques help promote training of a single student model that reflects knowledge of multiple heterogeneous teacher models.

According to one enhancement, a computer-implemented method further includes generating the pseudo-data samples respectively per class of the pre-trained teacher models. In this manner, a student machine learning model may receive comprehensive training from a variety of classes in different teacher models. Despite a lack of access to original training data, knowledge of names of the classes of the teacher models is used to enhance student model training.

According to one enhancement, the method further includes a teacher-specific steerable data generator producing the pseudo-data samples via: (a) using an autoregressive unconditional pre-trained language model (PLM) to generate class or attribute conditional text relevant to a label set of a respective one of the teacher models; and (b) implementing a weighted decoding mechanism that guides the base PLM, under influence of the respective one of the teacher models, towards a specific class or attribute of interest.

In this manner, training data for a student machine learning model is created through the guidance of the teacher models despite a lack of access to original training data that was used to train the teacher models.

According to one enhancement, the method further includes beginning the generation of the class or attribute conditional text by inputting a generic start token or a class-descriptive prompt into the PLM and comprises iterative next word prediction in response to an input of previously generated tokens. In this manner, vocabulary knowledge of a general language machine learning model or from a teacher model are used to initiate generation of pseudo-data that can be used as training data for a student machine learning model to transfer the knowledge from the teacher models despite a lack of access to original training data that was used to train the teacher models.

According to one enhancement, a method further includes applying one or more sampling strategies to generate the class or attribute conditional text from an output distribution of the PLM. In this manner, computing time and costs for generating pseudo-data that reflects knowledge of teacher models is reduced while still achieving effective and intelligible pseudo-data.

According to one enhancement, a method further includes that the one or more sampling strategies are at least one of top-k sampling and nucleus sampling. In this manner, statistical knowledge is applied to help reduce computing time and costs for generating intelligible pseudo-data that reflects knowledge of teacher models despite lack of access to original training data that was used to train teacher models.

According to one enhancement, the block-wise amalgamation includes (a) estimating an out-of-distribution (OOD) score to measure a respective confidence of the teacher models across different intermediate layers when the teacher models make predictions on input text; and (b) employing a block-wise integration with a selective transformer to self-regulate knowledge from the teacher models based on the OOD scores.

In this manner, compactness of a student model is promoted as knowledge from multiple layers across teacher models are combined together and integrated into a student model, for example, when the student model has a smaller, e.g., significantly smaller, number of layers than the teacher models have. Moreover, block-wise integration helps allow matching of representations coming from teacher models having different sizes or differing sizes of relevant layers for enhanced knowledge integration into a student model.

According to one enhancement, the block-wise integration includes producing the unified representation by assigning a respective weight for a respective representation at a block level of a particular teacher model corresponding to a confidence level of the OOD score of the particular teacher model. In this manner, efficient processing of teacher representations is promoted while combining knowledge from multiple teacher models to teach a single student model.

According to one enhancement, the block-wise integration technique of a method handles the varying number of layers between the teacher models and the student model by performing mean pooling over the layer representations within blocks of the teacher models. In this manner, data resource management of handling similar machine learning model representations is improved to promote compactness of a student model.

According to one enhancement, a method includes the student model being respectively smaller than each of the teacher models. In this manner, compactness of machine learning text classification is achieved as knowledge is transferrable to a lighter model which takes less storage space and requires less computing power to operate.

According to other enhancements, computer systems and computer program products configured to cause processor sets to carry out some or all of the computer operations corresponding to those described above achieve similar technological advantages as those described above.

The following described exemplary embodiments provide a computer system, a method, and a computer program product for data-free knowledge amalgamation for text classification. The availability of pre-trained models in various repositories has revolutionized the process of model training. However, concerns related to privacy, security, and intellectual property often prevent direct access to the original training data. Consequently, transferring knowledge from teacher models to student networks becomes a challenging task. To tackle this issue, the present embodiments help develop a knowledge amalgamation (KA) framework. This framework aims to train a lightweight student network that can effectively integrate knowledge from multiple teacher models with diverse areas of expertise. Notably, this knowledge integration is performed under data-free constraints, meaning that the original training data is not accessible during the process. The present disclosure describes this task as data-free knowledge amalgamation (DFKA). In contrast to the traditional knowledge distillation (KD) approach, where teacher models focus on a single labeled task, KA methods empower the student model to classify across a wider range of labels derived from all the teachers. The present embodiments advance the exploration and application of KA techniques in NLP while also addressing the challenge of not having access to the original training data of the teacher models.

To bridge this gap, the present embodiments introduce a machine learning framework called STRATANET (Selective Transformer based Self-Regulative Amalgamation Network), a framework specifically designed to facilitate data-free knowledge amalgamation in NLP. With STRATANET, the student machine learning model can effectively leverage the combined insights from multiple pre-trained teacher models, each possessing diverse areas of expertise. The references herein to a teacher model refer to a teacher machine learning model that provides knowledge for the training of another machine learning model. The references herein to a student model refer to a student machine learning model that receives training using information or data from another machine learning model. The STRATANET is used to train a lightweight and versatile student model from multiple pre-trained teacher models under data-free constraints. It addresses three critical factors: (a) the unavailability of training data for teacher models, (b) the presence of specialized teacher models with label sets that may have no overlap or partial overlap, and (c) the need to effectively combine knowledge from multiple heterogeneous teachers models. Heterogeneous teacher models refers to teacher models which have different architectures.

The present embodiments overcome limitations such as limited learning from diverse teacher expertise, reliance on a single teacher model or homogeneous architectures, lack of exploration in data-free knowledge amalgamation in the NLP domain, the need for access to the original training data, and impractical assumptions regarding model architectures. The principled framework like STRATANET overcomes these limitations and effectively perform data-free knowledge amalgamation in NLP.

In this work, a framework and comprehensive solution are provided that enable a compact student network (machine learning model) to learn from multiple pre-trained teacher models that have specialized knowledge. The learning for the student network occurs without accessing the original training data that was used to train the teacher models. This scenario is particularly challenging due to the unavailability of training data, the specialized knowledge of the teachers, and the need to effectively integrate the knowledge from heterogeneous teacher models. To overcome the limitations of traditional knowledge distillation methods and enable effective data-free knowledge amalgamation for text classification, the present embodiments introduce STRATANET, a data-free knowledge amalgamation (DFKA) framework. STRATANET is a dual-step modeling framework that enables the training of a lightweight and versatile student model by leveraging insights from multiple teacher models. Relevant teachers are identified using OOD-estimation. At every block level, OOD-estimation gauges the confidence of each teacher's block-level representation in classifying input text into its trained labels. The relevance of a teacher at block level ‘b’ is indicated by their confidence, as estimated by the OOD score. ST-AMALG, described subsequently, integrates this confidence information with the teacher representation to create a fused representation that aligns closely with relevant teacher representations. The intermediate layers of the student model are aligned with this fused representation at each block level. The knowledge amalgamation training process involves: (a) feeding pseudo-data samples to multiple teacher models and the student model in batches, (b) computing OOD-estimates at the block level for each input in the batch, reflecting the relevance of a teacher for a specific input, (c) utilizing confidence measures and teacher representations to produce a unified representation capturing relevant features, and (d) aligning student intermediate representations with the unified representation computed in the previous step, while also employing KL divergence to develop a compact and versatile student model. The feeding of pseudo-data samples to multiple teacher models in some embodiments occurs to all of the teacher models which are used to guide generation of pseudo-data. The feeding of pseudo-data samples to multiple teacher models in some embodiments occurs for some, most, or all of the generated pseudo-data to be fed to the to the teacher models and to the student model. In some embodiments, at least some pseudo-data samples generated by guidance from each of the multiple teacher models is fed to the to the teacher models and to the student model during the knowledge amalgamation portion of the process.

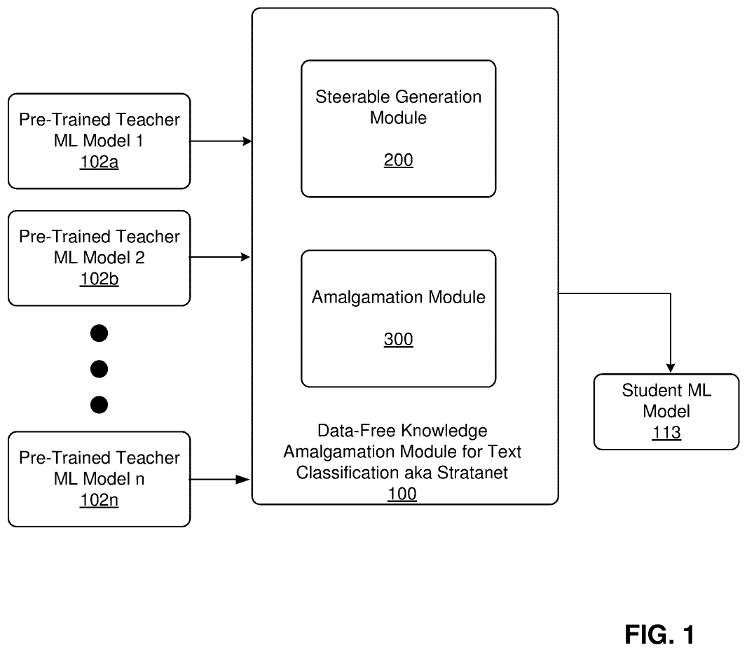

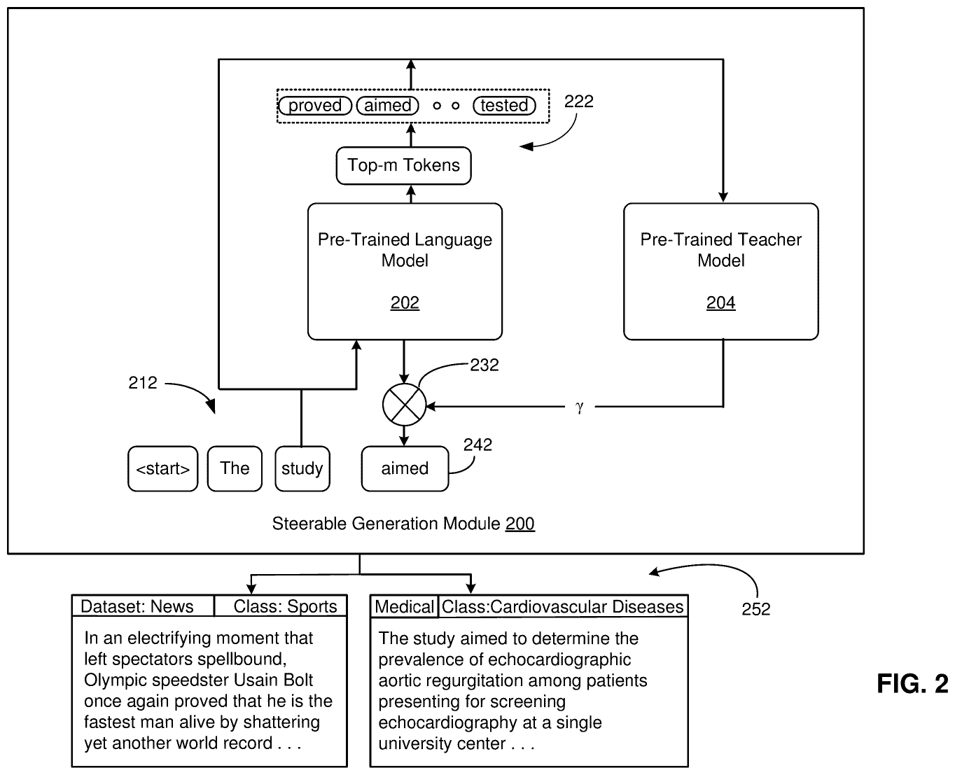

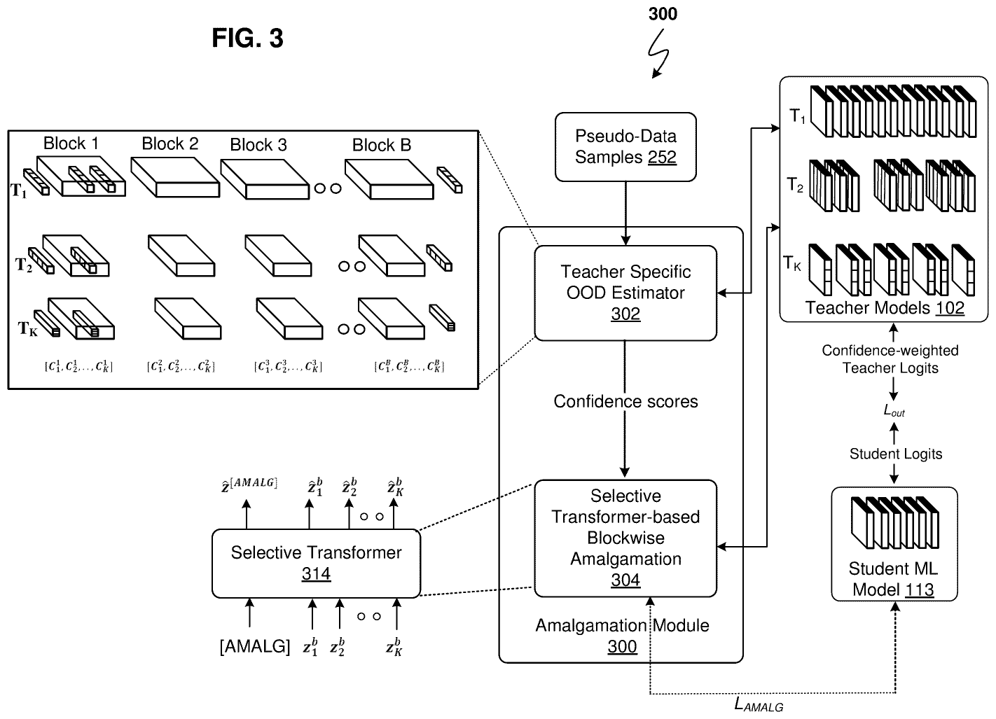

The STRATANET framework consists of two core components: the steerable data generator and the amalgamation module. FIG. 1 of the drawings illustrates the STRATANET as data-free knowledge amalgamation module for text classification 100 with its two core components-steerable generation module 200 and amalgamation module 300 and which works in conjunction with multiple pre-trained teacher machine learning models 102a, 102b, . . . 102n, to train a student machine learning model 113. FIG. 2 of the drawings illustrates details of the steerable generation module 200 of the STRATANET 100. FIG. 3 of the drawings illustrates details of the amalgamation module 300 of the STRATANET 100.

The pre-trained teacher models 102 are respectively based on an artificial neural network that has been trained to perform a natural language processing task such as text classification. Each of the teacher models 102 includes an input layer, an output layer, and one or more hidden or deep layers. In some examples, the teacher model 102 employs a transformer-based architecture, although it will be appreciated that other architectures may be used such as convolutional neural networks (CNN), recurrent neural networks (RNN), and other machine learning architectures suitable for natural language processing, text classification, and/or text generation. In some examples, the pre-trained teacher model 102 has been trained on an original training dataset.

In a particular example, the various pre-trained teacher models 102 are each pre-trained to perform text classification. Text classification includes fitting a sequence of unstructured text to one or more predefined classifications, also referred to as class dimensions. The sequence of text is then associated with a label of the classification. For example, in a binary classification task, a sequence of text could be assigned a label of 1 or 0, representing the categories pertinent to the task. For instance, in a movie review sentiment analysis, these labels might correspond to positive or negative sentiments. In a multi-class classification task, a sequence of text might be labeled with one or more topics related to the text sequence (e.g., sports, politics, business, etc.). During training, a classification module 208 of the teacher model 202 is adapted to receive a text sequence and a class label and to adjust its parameters to predict the class label. Then, during a classification phase the trained classification module 208 is able to receive that same text sequence or another similar text sequence without the label and correctly detect the appropriate classification for the text sequence based on its training, and output the label of the appropriate classification. As used herein, ‘class,’ ‘classification,’ ‘label,’ and ‘attribute’ may be used interchangeably.

In some examples, the various original training datasets for pre-training the teacher models include a corpus of unstructured text sequences. A class label is provided for each text sequence of the dataset. A text sequence is input to the model, the text sequence is classified by the model, and the model's classification is compared to the actual classification for the sequence. The one or more weights in the model are adjusted, the text sequence is reinput to the model in subsequent training epochs, and the model's classification is again compared to the actual classification. If the output is more correct, the adjustment to the weight is kept, otherwise the adjustment is discarded. Thus, the actual sequence classifications are used as ground truths for a loss function that is applied to the model. The loss function quantifies how well the model is performing by measuring the difference between the model's predictions and the actual target values. The goal during training is to minimize this loss function, effectively adjusting the model's parameters to make the model's predictions as close as possible to the true values. This process iterates until the model is able to predict the classification with a preconfigured rate of correctness and/or degree of confidence.

In a particular implementation, the various teacher models 102 include a respective transformer-based text classification neural network that utilizes a transformer architecture characterized by distinct layers with the output of one layer forming the input of the next. In an input embedding layer, a raw text sequence input is tokenized into subword or word tokens and individually embedded into high-dimensional vectors. To incorporate sequence order, positional encoding is added to the input embeddings by a positional encoding layer, thus providing information about token positions. In some examples, multiple transformer encoder layers feature multi-head self-attention mechanisms and feedforward neural networks. These layers capture dependencies between words and complex relationships. After the attention mechanism, a position-wise feedforward network including fully connected layers with rectified linear unit activation functions processes the output. In some examples, before the attention mechanism and after the feedforward network, layer normalization and residual connections are applied to enhance training stability and gradient flow. In some examples, global average pooling may be employed to obtain a fixed-size representation over the text sequence dimension. The output of the transformer encoder layers, or global average pooling layer is applied to multiple dense layers to map features to the desired output one or more of the class dimensions. To produce final predictions, an output layer employs activation functions like SoftMax for multiple classifications or sigmoid for binary classifications, depending on the classification task. In some examples, a loss function is also selected based on the classification task, using binary cross-entropy for binary classification or categorical cross-entropy for multi-class classification.

Given that the teacher models 102 are pre-trained, embodiments in accordance with the present disclosure are directed to training the student model 113 using data-free knowledge transfer in that, for reasons discussed above, the student model 113 is trained without providing the student model access to the original training dataset. The references in this disclosure to “data-free” refer to this aspect of the training of the student model 113 not including obtaining any access to the original training data that was used to train/pre-train the teacher models. The student model 113 may also employ a transformer, CNN, or RNN-based architecture. In some examples, the teacher models 102 and the student model 113 implement heterogeneous architectures in that one, some, or each of the teacher models 102 employs a different architecture than the student model 113 employs. In some examples, the student model 113 is compressed and smaller when compared to the teacher model 102, for example, by including fewer layers and/or parameters. In some examples, the student model 113 is not implemented by copying the layers of the teacher model 102.

Steerable Data Generator: The steerable data generator tackles the unavailability of original training data for teachers and is responsible for generating pseudo-data samples tailored to the label set of each teacher model. The steerable data generator utilizes a class-conditional text generation method that guides a base pre-trained language model to produce customized textual pseudo-data samples that are relevant to the specific teacher model. This approach addresses the challenge of unavailability of the original training data by generating synthetic data samples that mimic the distribution of each teacher's expertise. This generation of the synthetic training data aka pseudo-data allows the framework to mimic the distribution of expertise for each teacher, facilitating knowledge transfer without needing access to the teacher model original training data. By guiding a base pretrained language model using a post-processing module, the steerable data generator of STRATANET gains fine-grained control over the generated data, enhancing the effectiveness of knowledge transfer.

Block-wise amalgamation Module: The block-wise amalgamation module addresses the challenge of integrating knowledge from multiple teachers with varying levels of expertise and has two key functions.

Firstly, the block-wise amalgamation module includes a Teacher-specific out-of-distribution (OOD) Estimator that computes the confidence of each teacher model in making predictions for a given input text within their specific expertise. The OOD Estimator computes out-of-distribution scores at different levels of each teacher, identifying if an input falls within their specific expertise. This confidence estimation is crucial for effectively integrating the knowledge from multiple teachers and for effectively aligning the student model's intermediate representations with feature embeddings from the relevant teacher models.

Secondly, the amalgamation module employs a Selective Transformer-based Block-wisc Amalgamation component (ST-AMALG) with a selective transformer to perform a block-wise integration technique. The ST-AMALG selectively integrates the representations from different teacher models based on their confidence scores, allowing for the effective transfer of knowledge to the student model. A respective weight is assigned for a respective representation at a block level or per block level of a particular teacher model corresponding to a confidence level of the OOD score of the particular teacher model. For example, lesser weight is assigned to the representations from the less-confident teacher models for a prediction and a greatest weight is assigned to representations from a most relevant teacher model for a prediction. The ST-AMALG further refines the alignment of intermediate representations for the student model, grouping intermediate representations into blocks and selectively integrating knowledge based on confidence scores. A block herein refers to a group of representations of averaged-together different layers of the representations of a single teacher model or from multiple teacher models. In some instances, different teacher models have pseudo-data sample relevant representations in different sizes, e.g., generated from a different number of layers, and bringing these representations into a universal block size before amalgamating the blocks from different teacher models allows effective integration of knowledge from teacher models having different sizes/different number of layers. This approach ensures that the student model effectively leverages the valuable knowledge from each teacher while mitigating the potential uncertainties or errors, e.g., the uncertainties that may arise from handling input sequences outside their respective areas of expertise. The use of the estimation of the OOD scores enables the mitigation of uncertainties or errors propagated by less confident teacher models by selectively integrating informative representations from the teacher models.

By combining the steerable data generator and the amalgamation module, STRATANET enables the student model to learn from multiple teachers without accessing their original training data. STRATANET leverages a steerable data generator to create pseudo-data samples tailored to each teacher, enabling knowledge transfer even without access to their original training data. The Block-wise Amalgamation Module then selectively integrates the knowledge from different teachers based on confidence scores, aligning the student model's intermediate representations with the feature embeddings from the relevant teacher models. This approach allows for effective learning from multiple heterogeneous teacher models in a data-free setting. Overall, STRATANET offers a novel and comprehensive framework for learning from multiple teachers, demonstrating its effectiveness in text classification tasks under data-driven and data-free constraints. STRATANET facilitates the transfer of knowledge, expertise, and insights from diverse teacher models to the student network, resulting in a lightweight and versatile model. Experimental evaluations on benchmark text classification datasets demonstrate that the student model trained using STRATANET outperforms several baselines under data-driven and data-free constraints.

Selective Integration and Confidence Estimation: The amalgamation module of STRATANET employs a block-wise integration technique using a selective transformer. This selective transformer selectively integrates representations from different teacher models based on confidence scores. This approach ensures that the student model benefits from the valuable knowledge of each teacher while managing uncertainties or errors. Furthermore, this amalgamation module includes an embedding enrichment mechanism, denoted as ST-AMALG. The embedding enrichment mechanism enriches the embeddings from the teachers with additional information derived from the teacher's expertise, enhancing the discriminative power of the learned representations. The enriched embeddings play a vital role in guiding the student model towards better generalization and improved performance. This fine-grained control of knowledge integration sets the STRATANET apart from traditional knowledge distillation methods and plays a vital role in guiding the student model towards better generalization and improved performance.

STRATANET provides a framework that allows a lightweight student model to learn from multiple pre-trained teacher models without requiring access to their original training data. This data-free trainability is achieved through a steerable data generator that generates tailored pseudo-data samples and through an amalgamation module that selectively integrates the knowledge from different teachers based on confidence scores.

STRATANET offers several advantages over other known solutions in the field of data-free knowledge amalgamation and knowledge distillation. The advantages include:

Integration of Multiple Heterogeneous Teacher Models: STRATANET stands out by allowing the integration of knowledge from multiple pre-trained teacher models with diverse expertise, e.g., from teacher models trained with different classification training data. Unlike traditional knowledge distillation methods that typically focus on a single teacher or homogeneous ensembles, STRATANET has the capability to effectively handle teachers specialized in different sets of classes. This versatility enables the student model to learn from a broader range of knowledge and perform well across diverse label sets, making STRATANET suitable for various NLP tasks. This capability means STRATANET can integrate knowledge from multiple pre-trained teacher models with diverse expertise and effectively combine the knowledge from multiple teachers to produce a compact and versatile student model. This integration is a unique feature that sets STRATANET apart from existing knowledge distillation methods, which often deal with a single teacher or similar teachers.

Data-Free Knowledge Amalgamation in NLP: While data-free knowledge distillation methods have been explored in computer vision, STRATANET is a first-of-its-kind framework specifically designed for data-free knowledge amalgamation of multiple heterogeneous teacher models for text classification. STRATANET addresses the challenge of unavailability of the original training data by using a steerable data generator that produces pseudo-data samples tailored to each teacher model. This unique approach allows knowledge transfer without the need for accessing the original data. The STRATANET and the generated pseudo-data are applicable in scenarios where privacy, confidentiality, or intellectual property concerns restrict access to the training data. The pseudo-data samples facilitate the integration of knowledge from multiple heterogeneous teacher models.

Steerable Data Generator for Customized Data Synthesis: STRATANET incorporates a steerable data generator that guides a base pre-trained language model to generate customized text samples specific to each teacher's expertise. This fine-grained control over the generated data enhances the effectiveness of knowledge transfer. By generating pseudo-data samples tied to each teacher, STRATANET enables the student model to learn from teacher-specific distributions, improving its performance on diverse label sets.

Selective Integration and Confidence Estimation: The amalgamation module of STRATANET employs a block-wise integration technique using a selective transformer. It selectively integrates the representations from different teacher models based on confidence scores. This selective integration approach ensures that the student model benefits from the valuable knowledge of each teacher while mitigating uncertainties or errors that may arise from handling input sequences outside their areas of expertise. This adaptive and selective integration mechanism enhances the overall performance and reliability of the student model.

Performance and Versatility: Experimental evaluations demonstrate that the student model trained using STRATANET outperforms several baselines under both data-driven and data-free constraints. STRATANET achieves superior performance in text classification tasks, displaying its effectiveness in transferring knowledge from multiple teachers to the student model.

Thus, STRATANET offers advantages such as the integration of multiple heterogeneous teacher models, data-free knowledge amalgamation in NLP, a steerable data generator for customized data synthesis, selective integration based on confidence scores, and improved performance and reliability. Its uniqueness lies in being the first-of-its-kind framework specifically designed for data-free knowledge amalgamation in NLP, addressing the challenges and requirements of the text domain in a novel and effective manner.

Proof of Concept To briefly explain the working of the models, a specific text classification task, such as news classification, is considered in which the goal is to categorize news articles into different topics like World, Sports, Business, and Sci/Tech. An exemplary embodiment uses three pre-trained teacher models, each specializing in a subset of these classes: (a) Teacher Model 1 (World & Sports): This teacher model has expertise in distinguishing global news from sports-related content; (b) Teacher Model 2 (Business & Sci/Tech): This teacher model excels in identifying content related to financial matters and scientific/technological advancements; and (c) Teacher Model 3 (Multi-Class): This teacher model is trained to classify news articles into one of the three categories: “World”, “Sports”, and “Business”. Each of these three teacher models were trained with different training data. STRATANET applies its approach to integrate knowledge from these pre-trained teacher models.

Steerable Data Generation: STRATANET starts by generating pseudo-data samples for each class based on the expertise of the teachers. Each teacher is tied to a steerable data generator or sequentially tied to the same steerable data generator. The generator produces class-controlled text sequences of a specified length by estimating the conditional probabilities of generating each token given the previous context and the target class. By checking with the pre-trained teacher model for the probabilities, the pre-trained teacher model has precise control over the generated text, ensuring that the generated pseudo-data (text) aligns with the expertise of the teacher. This method combines the output probabilities of the language model with the likelihood estimate from the teacher model. The hyperparameter γ controls the strength of influence the teacher model has over the generation process. By adjusting γ, the level of guidance provided by the teacher is fine-tuned. For instance, for the “World” class the steerable data generator creates synthetic examples that mimic global news content. Similarly, the steerable data generator generates pseudo-data for “Sports”, “Business”, and “Sci/Tech” classes.

Block-Wise Integration: Given heterogeneous teacher models, each with a different number of layers, STRATANET employs a block-wise integration technique using a selective transformer. The student model tries to align its representation with the integrated knowledge from multiple teacher representations at the block-level.

(a) Confidence Estimation: STRATANET estimates the confidence of each teacher's prediction for a given class at any given block b. This is achieved using a Relative Mahalanobis distance (RMD) which computes out-of-distribution score for a new input associated with each teacher at block B. This use of the RMD ensures that the teacher representations are appropriately weighted for effective classification. For a news article from the “Sports” category, the representations of Teacher Model 1 (World & Sports) and Teacher Model 3 (Multi-Class) would have more weight assigned than Teacher Model 2 (Business & Sci Tech).

(b) Output Aggregation: In order to effectively amalgamate the knowledge present in the intermediate layers, the confidence score at each block b for each teacher model is utilized. By considering the block-level intermediate latent vectors from different teachers as a sequence of tokens, a selective Transformer-based amalgamation layer uses a dedicated token, [AMALG] (similar to [CLS]), that integrates the confidence-aware representations of the teacher models into a final block-level amalgamated representation. The integrated knowledge is used to train a compact student model for news classification. This student model inherits the collective insights from all three teachers, enabling the trained student model to effectively classify news articles into one of the four categories.

By following this approach, STRATANET effectively leverages the specialized knowledge of the three pre-trained teacher models to create a powerful student model for news classification.

Invention Description: Details The present embodiment achieve a goal of developing a data-free approach for knowledge amalgamation.

Problem Setup The present embodiments address the problem of learning a versatile yet lightweight student network from two or more pre-trained teacher models under data-free settings. Given K pre-trained teacher models

$$T = {\{ {T}_{i} \}}_{i = 1}^{K} ,$$

each with L_{T}_{ᵢ} layers and its own domain of expertise, i.e., performing a cᵢ-class classification task with few overlapping or disjoint set of labels

$${Y}_{i} = {\{ {y}_{i}^{j} \}}_{j = 1}^{{c}_{i}}$$

our goal is to train a compact student model S with L_{S}-layers such that it can compute predictions over the union of all the label sets,

$$Y = {⋃}_{i = 1}^{K} {Y}_{i} and {L}_{S} < min ( {\{ {L}_{{T}_{i}} \}}_{i = 1}^{K} ) .$$

Proposed Approach and Overview In this section, an overview of the dual-step modeling framework, STRATANET (short for Selective Transformer based Self-Regulative Amalgamation Network), that aims to train a lightweight versatile student model from multiple teachers under data-free constraints is provided. The following factors are taken into account in the approach of the present embodiments: (a) the unavailability of training data, (b) the presence of specialized teachers with label sets that may have no overlap or partial overlap, and (c) the capability to combine knowledge from multiple heterogeneous teachers. The STRATANET framework includes two core components. The first component, denoted as Gᵢ, is the teacher-specific steerable data generator. This data generator directs a base pre-trained language model, P, to generate customized text that caters to the specific teacher, Tᵢ. This component alleviates the challenge of data unavailability by producing pseudo-data samples. The second component, referred to as the amalgamation module, performs two key functions. Firstly, the amalgamation module computes the confidence of each teacher to make predictions for a given input text within their specific expertise. Secondly, the amalgamation module employs a block-wise integration technique with a selective transformer to combine the knowledge acquired from multiple teachers. This integration approach takes advantage of the confidence score to appropriately assign weights to the representations of different teacher models, thereby facilitating the effective handling of diverse teacher architectures.

Steerable Data Generator To overcome the challenge of unavailability of the original training data for teacher models, a class-conditional text generation method is utilized that generates pseudo-data samples specifically tailored to the label set of the teacher Tᵢ. Given a teacher model Tᵢ and any class attribute c∈Yᵢ, a steerable text generator, Gᵢ, produces a class-controlled text x of length N as follows:

$$P ( {x}_{1 : N} \vert c ) = {\prod }_{t = 1}^{N} P ( {x}_{t} \vert {x}_{1 : t - 1} , c ) \qquad ( 1 )$$

The steerable text generator applies an inference-time controllable generation method to steer an unconditional language model towards the desired class attribute relevant to a specific teacher. This applying involves implementing a flexible generation module for each teacher Tᵢ, which focuses on producing pseudo-data samples

$${D}_{i}^{P} = ( {X}_{i}^{p} , {\hat{Y}}_{i}^{p} )$$

specifically designed for training the student model. The generation process entails guiding a base pre-trained language model (PLM), denoted as P, using a post-processing module. By adjusting the parameters during the decoding phase, the generator exhibits varying degrees of attribute control over the text sampled from the chosen base PLM. FIG. 2 shows that the steerable generation module 200 includes a pre-trained language model 202 being guided by a pre-trained teacher model 204 to produce pseudo-data 252, e.g., intelligible pseudo-data.

The present embodiments include an implementation of a domain-relevant autoregressive PLM like GPT-2(S/M/L) as the pre-trained language model 202 to sequentially sample new token xᵢ at time step t by conditioning on previously generated tokens, x_{1:t-1}. The choice of the PLM is flexible, allowing for the replacement of any language machine learning model, e.g., large language model, relevant to the task domain without causing significant changes to the approach. In at least some embodiments, the pre-trained language model 202 is a large language model. In some examples, the pre-trained language model 202 is an autoregressive unconditional pre-trained language model (e.g., GPT, GPT-2, or others). An autoregressive language model generates text by predicting the next word or token in a sequence based on the preceding context, incrementally building the output by conditioning each prediction on the previously generated elements. The output of an autoregressive language model is a probability distribution over the vocabulary. The word with the highest probability is chosen as the predicted next token. The autoregressive language model can also be configured to output its top-k tokens with the highest probabilities as the top-k predictions for the next word in the sequence. As will be explained in detail below, the teacher model can use these top-k tokens 204 to guide the language model 202 into generated synthetic training data tied to a class/label of interest. Although the language model 202 is shown in the drawings as a component of the module 200 and, therefore, of the STRATANET 100, it will be appreciated that the language model 202 may be an independent system and may be, in some examples, remote from the host system of the teacher model 204 and has its function performed as a part of accessing this remotely located language model 202.

In some implementations, the steerable generation module 200 uses the output of the language model 202 to generate class-conditional text samples that relate to the text classification task. Weighted decoding is applied by the steerable generation module 200 to the output of the language model 202 to influence the output toward a particular classification. For example, to generate synthesized data samples, the language model 202 generates probabilities for a next token based on a sequence of tokens from previous timesteps. The steerable generation module 200 guides the language model 202 in selecting a next token that has a high probability of producing a language model output that falls within a particular classification. For example, given a token vector ‘The film was . . . ’ the language model 202 generates a probability distribution for a potential next token from the model's vocabulary. In one example, the top k next tokens identified by the language model 202 are selected as a candidate set and each token in the set is concatenated with the token vectors (e.g., ‘The film was great’, the ‘The film was long’, etc.). The steerable generation module 200 determines, for each candidate token, the probability that the concatenated text containing the candidate token from the current timestep will be classified with the particular classification related to the text classification task. The teacher model 204 derives this probability from its own training based on the original training dataset and based on inputting the candidate token into the teacher model 204 and, in response, receiving a probability as part of the output of the teacher model 204. This process is iterative through multiple timesteps. The text string resulting from this iterative process is a synthesized data sample that corresponds to the particular classification label C and is added to a synthesized dataset. As the process iterates, synthesized intelligible pseudo-data samples including syntactically-correct class-conditioned text are created. These synthesized pseudo-data samples are added to a total synthesized dataset that will subsequently be used to train a student model 113.

FIG. 2 illustrates the previously-generated tokens as 212 that are input into the pre-trained language model 202 to cause the pre-trained language model 202 to perform this sequential sampling. The sequential sampling occurs as the PLM 202 performs prediction of a most appropriate next suitable word/token for the sequence. FIG. 2 shows these predicted next words 222 that are output by the PLM 202 in response to the PLM 202 receiving the previously-generated tokens 212 as input. The text generation process, can be initiated with R(c), representing either a simple start token (e.g., <BOS>) or class-descriptive prompts to steer the overall data generation process. Formally,

$${x}^{p} ∼ {G}_{i} ( P , {T}_{i} , R ( c ) ) \qquad ( 2 )$$

where Gᵢ is the steerable generator tied to the teacher Tᵢ. Based on a recent study, a variant of the weighted decoding method is adopted to generate class-conditional text using a pre-trained unconditional language model, denoted as P. In this approach, the generation process is modeled by incorporating a Bayesian factorization as follows:

$$P ( {x}_{t} \vert {x}_{1 : t - 1} , c ) α P ( {x}_{t} \vert {x}_{1 : t - 1} ) {P ( c \vert {x}_{1 : t} )}^{γ} \qquad ( 3 )$$

Here, γ represents a hyperparameter for control strength. The first term corresponds to the output probabilities generated by the chosen PLM 202, while the second term relies on the teacher model 204 to estimate the likelihood of the generated text (up to the current time step t) being classified under the class attribute c. During the sampling process, the value of γ regulates the influence of the teacher model. By multiplying the output probabilities of both terms at multiplication 232, an unnormalized probability score is obtained, which is then renormalized to obtain the re-ranked or re-scored hypotheses. The renormalization occurs by using log-probabilities for numerical stability.

The impact of the teacher model 204 is regulated by adjusting a control strength hyperparameter γ. Weighted decoding entails merging the probabilities (i.e., a weighted decoding parameter) from the hyperparameter-controlled teacher model 204 with those from the language model 202 for candidate tokens corresponding to the classification c. Accordingly,

$$P ( {x}_{1 : T} \vert c ) = {Π}_{t = 1}^{T} P ( {x}_{t} \vert {x}_{1 : t - 1} , c )$$

therefore P(xₜ|x_{1:t-1}, c) is proportional to P(xₜ|x_{1:t-1}, c)P(c|x_{1:t-1})^{γ}. Accordingly, the steerable generation module 200 provides a weighted decoding mechanism that steers the language model 202 towards generating a text sequence related to a specific classification of interest, where, in some examples, a weighted decoding parameter is a hyperparameter-controlled probability generated by the teacher model 204 for the classification c that is combined with the probability computed by the language model 202 for a set of a candidate tokens. If the probability does not exceed a pre-determined threshold, in some instances the produced new token is discarded and not included for the pseudo-data.

One of the primary challenges in this approach is the computational complexity associated with teacher-guided sequence sampling. To compute the second term in Equation 3, ideally the class probability P(c|x_{1:t}) needs to be estimated, which involves evaluating P(c|x_{t:t-1}, xₜ) for every token in the vocabulary V at the t^{th} timestep. However, computing this probability for all tokens can be computationally expensive. In order to reduce the inference time, sampling strategies such as top-k or nucleus sampling are implemented. These strategies help exclude low-probability tokens and focus on a subset of potential candidate tokens for teacher guidance. In essence, tokens with low probabilities P(xₜ|x_{1:t-1}) from the language model (PLM) are discarded or filtered out, even if the teacher model assigns high weights P(c|x_{1:t}). Instead, the top-m tokens with the highest probabilities are passed through, which are then weighed by the teacher model. These top-m tokens are selected based on a specific sampling strategy (e.g., in the case of top-k sampling, k<m<<|V|). Through the experiments, it has been shown that setting m to 100 works well in practice. FIG. 2 shows a sampled word 242 that passes the filtering and is added to the previously-generated tokens 212 to create a next new set of previously-generated tokens 212. This new set is then input into the pre-trained language model 202 to repeat the process to obtain another new sampled word 242 to add to the token set. Sampled words that do not exceed a pre-determined relevancy threshold based on an output of the multiplication evaluation described above are discarded. Finally, by utilizing some or all of the teacher-specific steerable data generators

$${\{ {G}_{i} \}}_{i = 1}^{K} ,$$

pseudo-data samples for classes in Y are generated. These samples are represented as where

$${D}^{p} = {⋃}_{i = 1}^{K} {D}_{i}^{p} ,$$

where

$${D}_{i}^{p}$$

corresponds to the pseudo-data samples specifically generated for the teacher Tᵢ.

FIG. 2 shows two examples of the pseudo-data samples 252: one from a class of sports in a news dataset and one from a class of cardiovascular diseases in a medical dataset. The first of the pseudo-data samples 252 starts with “In an electrifying moment that left spectators spellbound, Olympic speedster Usain Bolt once again proved that he is the fastest man alive by shattering yet another world record.” The second of the pseudo-data samples 252 starts with “The study aimed to determine the prevalence of echocardiographic aortic regurgitation among patients presenting for screening echocardiography at a single university center.” As explained below and illustrated in FIG. 3, the pseudo-data samples 252 are input into the amalgamation module 300 to then help cause the student machine learning model 113 to be trained.

Block-wise Amalgamation Module A Block-wise amalgamation module 300 is provided and illustrated in FIG. 3 and includes two sub-components: (a) Teacher-specific OOD Estimator 302, a lightweight method to compute an out-of-distribution (OOD) score across different levels of each teacher and (b) Selective Transformer-based Block-wise Amalgamation Module (ST-AMALG) 304, a block-wise adaptive strategy employed to select the informative states from relevant teachers based on the OOD scores and integrate them for facilitating effective transfer to the student model.

Teacher-specific OOD Estimator Due to the diverse label sets,

$${\{ {Y}_{i} \}}_{i = 1}^{K}$$

(overlapping or disjoint, as explained above), used to train the pre-trained teacher models,

$${\{ T \}}_{i = 1}^{K} ,$$

any input text from and unseen category for a specific teacher model is deemed OOD for that teacher. Consequently, the extracted features from that teacher's intermediate layer may not be self-sufficient for effective knowledge transfer to the student model. Moreover, the present embodiments help build on observations that (a) Transformer-based models often encode transferable features in their intermediate layers, with no single layer being the most transferable, and (b) the final layers of models such as BERT are highly task-specific. Taking these factors into consideration, layer-wise teacher-specific lightweight OOD estimators are built, which are elaborated upon below.

OOD Score Computation: Given an input text x∈Xᵢ belonging to a label y∈Ŷᵢ, a transformer-based pre-trained teacher model, Tᵢ, produces contextual token-level latent embeddings at each layer l∈L_{T}_{ᵢ}, which are accumulated into a single latent representation, denoted as

$${h}_{i}^{l} ∈ {R}^{{d}_{i}} ,$$

by averaging the token-level latent embeddings. For the input text, the superscript p indicating pseudo-data samples 252 in

$${D}_{i}^{P} = ( {X}_{i}^{p} , {\hat{Y}}_{i}^{p} )$$

are omitted for brevity. Here, dᵢ refers to the dimensions of the latent representations at the i^{th} teacher model. All latent representations have the same dimension in the transformer models across different layers. To compute an OOD score for any new input x_{new}, a Mahalanobis distance (M_{D}) based OOD detection technique is used that can be applied on the top of any pretrained model. For an in-distribution (I_{D}) dataset with cᵢ-labels associated with the teacher Tᵢ, an M_{D} technique fits cᵢ-class conditional Gaussian distributions N(μ_{y}, Σ); μ_{y}∈R^{d}^{ᵢ}, Σ∈R^{d}^{ᵢ}^{×d}^{ᵢ}, to each of the cᵢ ID classes based on a training latent representation

$${h}_{i}^{l} .$$

However, a Relative Mahalanobis distance (RMD) is implemented that outperforms the performance of MD in OOD detection for both near and far-OOD scenarios by calculating the distance between the class-conditional Gaussians and a single background Gaussian using data from all classes. For an input x_{new} with the latent representation

$${\hat{h}}_{i}^{l}$$

at layer l, RMD is formulated as:

$${RMD}_{y} ( {\hat{h}}_{i}^{l} ) = {MD}_{y} ( {\hat{h}}_{i}^{l} ) - {MD}_{b g} ( {\hat{h}}_{i}^{l} ) \qquad ( 4 )$$

$${MD}_{y} ( {\hat{h}}_{i}^{l} ) = {( {\hat{h}}_{i}^{l} - {μ}_{y} )}^{T} {\sum }^{- 1} ( {\hat{h}}_{i}^{l} - {μ}_{y} ) \qquad ( 5 )$$

$${C}_{i}^{l} ( {\hat{h}}_{i}^{l} ) = - {min}_{y} - \{ {RMD}_{y} ( {\hat{h}}_{i}^{l} ) \} \qquad ( 6 )$$

where

$${C}_{i}^{l}$$

refers to the confidence score of x_{new} being in-domain for Tᵢ based on representation at layer l, μ_{y} is a class-conditional mean vectors and Σ is the covariance matrix, MD_{bg} indicates Mahalanobis distance of

$${h}_{i}^{l}$$

to the background distribution fitted to the entire training data usually. RMD score serves as a contrastive measure to compare the proximity of a sample between the training domain and the background domains. Higher scores correlate with a higher degree of out-of-distribution characteristics, which in turn results in a lower ID confidence score,

$${C}_{i}^{l} .$$

In specific situations, an alternative to calculating confidence scores for each layer is to partition the intermediate layers into B blocks and apply a similar procedure outlined in Equations (4)-(6). When employing this approach, the latent representation

$${\hat{h}}_{i}^{b}$$

for a given block b is obtained by performing mean pooling over the layer representations contained within that block b. In some of the present embodiments, a held-out subset of pseudo-data samples

$${\hat{D}}_{i}^{p} ,$$

is used, generated for the labels of each teacher Tᵢ.

Selective Transformer-based Block-wise Amalgamation The Block-Wise Knowledge Amalgamation component aligns the student network's intermediate representations with the feature embeddings of the relevant teacher models. Given the goal of transferring the knowledge from larger heterogeneous teachers to a lightweight student model, the intermediate representations are aligned in a block-wise manner to handle the varying number of layers between the teacher and student networks. Thus, the total number of blocks is set to be equal to the number of intermediate student layers, and the number of grouped layers may vary across each teacher network Tᵢ. To amalgamate the knowledge present in the intermediate layers into a unified representation, the confidence score at each block b is utilized for each teacher Tᵢ to compute a confidence-aware blockwise intermediate representations,

$${z}_{i}^{b} .$$

Following the literature of multimodal analysis, the block-level intermediate latent vectors from K teachers,

$${\{ {z}_{i}^{b} \}}_{i = 1}^{K} ,$$

are treated as a sequence of tokens to be fed to a Selective Transformer-based amalgamation layer (ST-AMALG) 304 that includes a selective transformer 314. A special token [AMALG] is introduced in order to integrate the confidence information enriched representations from the teachers into a final block-level amalgamated representation,

$${\hat{z}}_{T}^{b}$$

that is referred to as a unified representation. The process produces one or more such unified representations during the training over the course of one or more batches of pseudo-data samples to train the student model using guidance from multiple teacher models. AMALG is similar to the commonly used [CLS] and is a learnable vector. Formally,

$${z}_{i}^{b} = f ( {h}_{i}^{b} ) + g ( {C}_{i}^{b} ) \qquad ( 7 )$$

$${\hat{z}}_{i}^{b} = ST - AMALG ( {\{ {z}_{i}^{b} \}}_{i = 1}^{K} ) \qquad ( 8 )$$

where f, g are linear layers to enrich the block-level embeddings.

Training Objectives For effective knowledge amalgamation, different objective losses are obtained that operate on the intermediate layers and the output prediction layer. In order to direct the intermediate layers of the student towards the teachers' amalgamated representation, a loss function based on the L2-normalized distance between projected block-level representation

$${\hat{z}}_{S}^{b}$$

of the student and the corresponding amalgamated embedding of the teachers is introduced. Finally, the total loss of transferring the block-wise knowledge from the teachers to the student network is calculated as:

$$\begin{matrix}{L}_{AMALG} = {\sum }_{b = 1}^{B} {L}_{AMALG}^{b} \\ s . t . {L}_{AMALG}^{b} = {‖ {\hat{z}}_{S}^{b} - {\hat{z}}_{T}^{b} ‖}_{2}^{2}\end{matrix} \qquad ( 9 )$$

For the output prediction layer, the KL-divergence between the prediction and estimated distribution is computed as:

$${L}_{out} = KL ( \hat{T} ( x ) , \hat{S} , τ ) \qquad ( 10 )$$

where KL denotes the Kullback-Leibler divergence loss based on confidence weighted combination of Teacher models and τ is the temperature.

The STRATANET trains the student model 113 by applying the pseudo-data samples 252 iteratively to the student model 113 and to the teacher models 102 in successive epochs. An epoch typically entails training the student model 113 through all of the pseudo-data samples once. Multiple epochs of the training are usually performed meaning that the student model 113 usually undergoes training on the entire set of pseudo-data samples multiple times. The pseudo-samples are fed in batches to both the student model and the teacher models, following which they are optimized for the objective/loss function through the backpropagation. For one batch submitted, the output logits of the student model 113 and the respective output logits of the teacher models 102 are compared by the STRATANET 100 to determine a loss for that batch. The STRATANET 100 computes a loss function such as Kullback-Leibler (KL) divergence to calculate the difference between the teacher models' classifications and the student model's classifications in the pseudo-data. The amalgamation module 300 supplies weighted loss parameters to the student model 113, which updates its parameters (e.g., biases and weights) through back propagation to minimize the loss.

In some implementations, to determine the loss, the respective output logits of the teacher models 102 and the output logits of the student model 113 are interpolated to determine the KL divergence. In non-binary classification scenarios, where there are more than two classes, the term ‘logit’ refers to the vector of raw, unnormalized prediction scores for each class dimension before applying a SoftMax activation function that is used to convert these raw scores into class probabilities that sum to 1. The KL divergence is used as a loss function to update the student model 113.

In other embodiments, other techniques besides KL divergence are implementable for evaluating probability distribution of predictions of the teacher models compared to probability distributions of the student model for a second loss of the combined loss function for optimizing the student model. For example, Shannon-Jensen divergence, Wasserstein divergence, Fisher divergence, and/or least squares analysis are applied to evaluate the probability distribution differences between teacher models and student model in some embodiments.

Experiments In this section, evaluation settings, including datasets and baselines are summarized. The experiments address the following research questions: (RQ1) How effective is the new model described herein compared to other baseline approaches for knowledge distillation in data-driven and data-free settings? (RQ2) What is the impact of each component in our model on overall performance? (RQ3) How does the new model perform when multiple heterogeneous teachers are involved?

Datasets To assess the effectiveness of the new DFKA approach described herein, experiments were performed using the following text classification datasets: (a) AG News: It consists of news articles grouped into four major classes—World, Sports, Business, and Sci/Tech. (b) IMDb Reviews: This dataset contains academic paper abstracts from five different domains—business, AI, sociology, transport, and law. (c) Ohsumed: It comprises medical abstracts specifically related to cardiovascular diseases. A focus is provided on single-label text categorization and exclusion of documents that belong to multiple categories.

Baselines A comparative analysis of the STRATANET model with data-driven and data-free baselines is provided. Here is a summary of the baselines:

Teacher Models, which are used to predict individually. Zero probabilities are assigned to classes outside the expertise of each teacher model. Ensemble, which concatenates the output logits from all the teachers to obtains predictions over all the labels Y. MUKA-Hard/Soft, which is a data-driven KA method that uses Monte-Carlo Dropout based model uncertainty to guide the student training. Vanilla KA (R/CD): which aims to mimic the soft targets produced by the logits combination of all teacher models using KL-divergence. In data-free scenario, we consider two settings—(i) Random Text (R): The student model is trained on text sequences constructed using randomly selected words from the vocabulary of the pre-trained teacher models; and (ii) Cross-Domain Texts (CD): The student model is trained on cross-domain text corpora like Wikitext-103. AS-DFD, which is a data-free knowledge distillation approach. This model is modified for data-free knowledge amalgamation (DFKA) scenario by crafting pseudo-embeddings for each teacher and a student model is trained using self-supervision and KL-divergence. STRATANET, which is the complete DFKA model as described with the present disclosure and that generates pseudo-data samples and leverages the produced data for knowledge amalgamation. The present embodiments include training a compressed student model (e.g., BERT₆) using a confidence score that selectively amalgamates the knowledge from intermediate and output layers of multiple teachers.

Implementation Details The STRATANET implementation in some embodiments is based on PyTorch10, Huggingface and PyTorch Lightning11. The model hyperparameters are tuned using grid-search. For the generation module, a maximum of 128 tokens is sampled. The top 200 tokens were selected using the nucleus sampling method with a sampling threshold of p=0.9. For Ohsumed dataset, BioGPT was used in order to tailor the data generation process to the domain of interest. Trained on large-scale PubMed abstracts, BioGPT is a specialized Transformer language model designed for generating and mining biomedical text. In the present experiments, a compressed BERT model with 6 layers, referred to as BERT₆, is used as the student model. Table 1 below shows the tuned hyperparameters used by both the generation and amalgamation component of the STRATANET model.

TABLE 1
Hyperparameters used by different components
of our proposed PRODGEN model.

| Hyperparameter | Value |
|---|---|
| Pre-trained LM | GPT-2 (S/M/L) or BioGPT |
| Learning Rate | 2e−5 |
| Batch Size | 16 |
| #Epochs | 10 |
| Dropout | 0.2 |
| Optimizer | AdamW |
| Learning Rate Scheduling | linear |
| Weight Decay | 0.01 |
| Warmup | 2 epochs |
| Gradient Clipping | 1.0 |
| Sampling Method | Nucleus |
| Sampling - p | 0.9 |
| KD Temperature - τ | 0.75 |

Training details Given steerable data generators

$${\{ {G}_{i} \}}_{i = 1}^{K}$$

tied to teachers

$${\{ T \}}_{i = 1}^{K} ,$$

a student training transfer set, denoted as D^{p}, is produced by combining the pseudo-data samples generated for all the labels across all of the teacher models. Next, the intermediate layers are divided into B-blocks such that the number of layers in each block may vary according to the number of layers in the teacher model. In some embodiments, B is set to the number of intermediate layers in the compressed student model S, i.e., BERT₆ and the number of layers within each block for each teacher are computed accordingly. A subset of pseudo-data samples generated for each teacher Tᵢ, represented as

$${\hat{D}}_{i}^{p} ,$$

is used compute the layer-wise distribution statistics for OOD estimation. Each pseudo-data sample undergoes a verification across all teacher models. This verification involves estimating layer-wise out-of-distribution (OOD) scores across all of the teacher models. This process provides insights into the confidence level of each teacher model in predicting the given sample among the trained labels of the respective teacher model. Finally, the student training transfer set D^{p} is used to train the student model by: (a) computing the confidence of teachers' block-wise features in predicting each input text, (b) amalgamating the confidence-enriched representations from teachers and (c) optimizing the weighted sum of intermediate (L_{AMALG}) and output prediction layer (Lₒᵤₜ) losses, expressed as:

$$L = λ \cdot {L}_{AMALG} + ( 1 - λ ) \cdot {L}_{out} .$$

Results and Discussion: Efficacy of STRATANET (RQ1) Overall Performance The evaluation results are presented in Table 2, providing a summary of our findings. To ensure a fair comparison, our baselines incorporate cross-domain data (CD), similar to the present model that utilizes a resource like PLM. Additionally, a variation of the datafree knowledge distillation method for DFKA is implemented for comparison purposes. Compared to all the baselines, the present STRATANET model demonstrates significant improvement over other DFKA baselines across various text classification datasets. Notably, the compact student model trained under data-free settings according to STRATANET shows an approximately 4% increase in performance compared to the best-performing data-driven model in certain cases. This appears to show that knowledge from the intermediate layers are beneficial for the performance improvement.

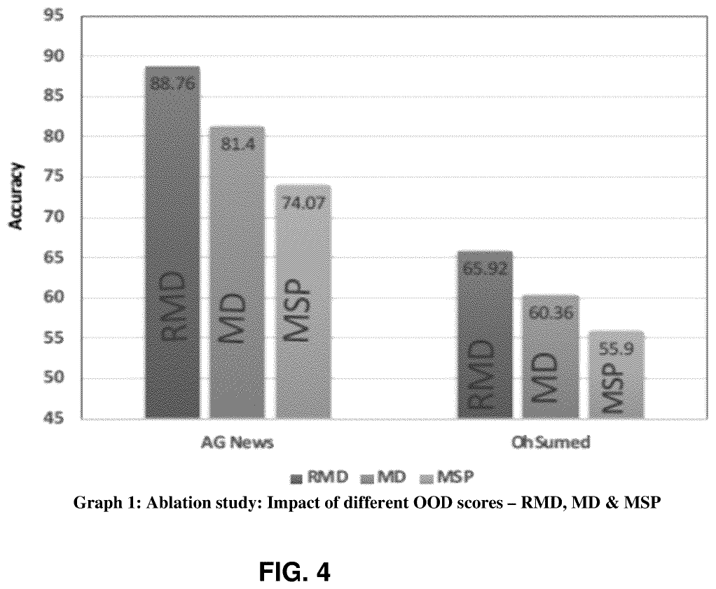

Ablation Studies (RQ2) Effect of RMD In order to measure the effect of Relative Mahalanobis distance (RMD), the OOD score computation is substituted using other methods including: (a) embedding-based Mahalanobis distance (MD) and (b) maximum softmax probability (MSP) at the final layer. FIG. 4 illustrates a Graph 1 that is a bar chart showing how use of these different techniques to determine the OOD score affects the overall performance of the model. RMD OOD score helps achieve the best performance of our model.

TABLE 2
Evaluation results on benchmark text classification datasets
compared to other baseline methods, averaged over three runs.
Standard deviations are also reported. Our method achieve
statistically significant improvements over the closest baselines
(p < 0.01). Bold face indicates the best results.

| | AG | 5Abstracts | |
|---|---|---|---|
| Models | News | Group | OhSumed |
| Supervised | 94.6 | 90.7 | 70.5 |

Data-Driven Methods

| | | | |
|---|---|---|---|
| Teacher 1* | 49.9 | 42.0 | 36.2 |
| Teacher 2* | 47.5 | 51.5 | 38.18 |
| Ensemble* | 59.8 | 62.3 | 45.48 |
| MUKA-Hard* | 87.0 | 79.0 | — |
| | (±0.40) | (±0.82) | |
| MUKA-Soft* | 87.1 | 79.3 | — |
| | (±0.19) | (±0.85) | |

Data-Free Methods

| | | | |
|---|---|---|---|
| Teacher 1 | 45.8 | 41.75 | 32.8 |
| Teacher 2 | 46.9 | 46.88 | 35.6 |
| Ensemble | 55.86 | 53.67 | 41.94 |
| Vanilla KA | 58.9 | 56.27 | 47.33 |
| (R) | (±3.19) | (±2.76) | (±4.41) |
| Vanilla KA | 62.43 | 61.55 | 50.91 |
| (CD) | (±2.62) | (±0.91) | (±2.8) |
| AS-DFD | 74.89 | 69.83 | 56.08 |
| | (±0.89) | (±1.06) | (±1.6) |
| STRATANET | 88.76 | 83.6 | 65.92 |
| (Ours) | (±0.19) | (±0.28) | (±0.41) |

Impact of ST-AMALG To evaluate the contribution of ST-AMALG, two variants are introduced: (a) STRATANETₘᵤₗ simply multiplies the block-level confidence score with the teacher embeddings instead of the embedding enrichment (as in Equation (7)), (b) STRATANET_{noST} removes ST-AMALG and uses a linear layer on top of confidence weighted sum of teachers' latent vectors in Equation (8). Table 3 shows that both the variants lead to significant performance degradation. This apparent degradation reinforces the value of the overall STRATANET model performance. These tests validates the intuition that the embedding enrichment and ST-AMALG serve as critical components to select the important block-level features from different teacher models.

TABLE 3
Ablation study: Impact of ST-AMALG.

| Methods | OhSumed | % Change |
|---|---|---|
| STRATANET | 65.92 | — |
| STRATANETₘᵤₗ | 62.49 | ~−5% |
| STRATANET_{noST} | 60.86 | ~−8% |

Effect of Multiple Heterogeneous Teachers (RQ3) To showcase the model's capability to generalize to multiple heterogeneous teachers, three-teacher (1 BERT-base, 1 RoBerta-base and 1 ALBERT) scenarios and four-teachers (1 BERT-base, 2 RoBerta-base and 1 ALBERT) scenarios with their heterogeneous architectures are considered. The results are listed in Table 4. The results indicate that the performance of student models trained using baseline KA methods drops as the number of teachers is increased, indicating that it is challenging to amalgamate more teachers. However, the student model trained using the embodiments of the present disclosure not only has an improved accuracy but also maintains the improved accuracy as the number of teachers increases. The highly consistent results confirm the effectiveness of the embodiments of the present disclosure across various experimental settings.

TABLE 4
Effect of Multiple Heterogeneous teachers on OhSumed dataset

| | 3-Teachers | 4-Teachers |
|---|---|---|
| Methods | {7, 8, 8} | {5, 6, 6, 6} |
| STRATANET | 66.35 | 66.18 |
| | (±0.17) | (±0.11) |
| Vanilla KA (CD) | 46.28 | 43.87 |
| AS-DFD | 55.15 | 54.09 |

TABLE 5
Ablation Study: Effect of heterogeneous
teachers & number of student layers

| Models | Homogeneous | Heterogeneous |
|---|---|---|
| Teacher 1 | 49.8 | 48.9 |
| Teacher 2 | 48.86 | 50.6 |
| Ensemble | 60.25 | 60.54 |
| AS-DFD₆ | 75.16 | 63.89 |
| STRATANET₆ | 89.16 | 88.53 |
| AS-DFD₄ | 72.80 | 61.72 |
| STRATANET₄ | 88.29 | 86.65 |

Additional Analysis Effect of heterogeneous teachers and student model layers are shown above in Table 5: As described above, experiments were conducted using a compressed BERT₆ model, and the results demonstrated no significant performance degradation. To delve deeper, additional experiments involving {6, 4}-layer student models with different teacher configurations: a homogeneous setting (T₁, T₂: BERT_{large}) and a heterogeneous setting (T₁: BERT_{large}, T₂: ROBERTA_{large}) were run. The evaluations on the AG News dataset reveal the poor performance of the data-free baseline AS-DFD with compressed layers, highlighting the challenges of the heterogeneous setting. However, the STRATANET framework demonstrates consistent and robust performance under both configurations, even with higher compression.

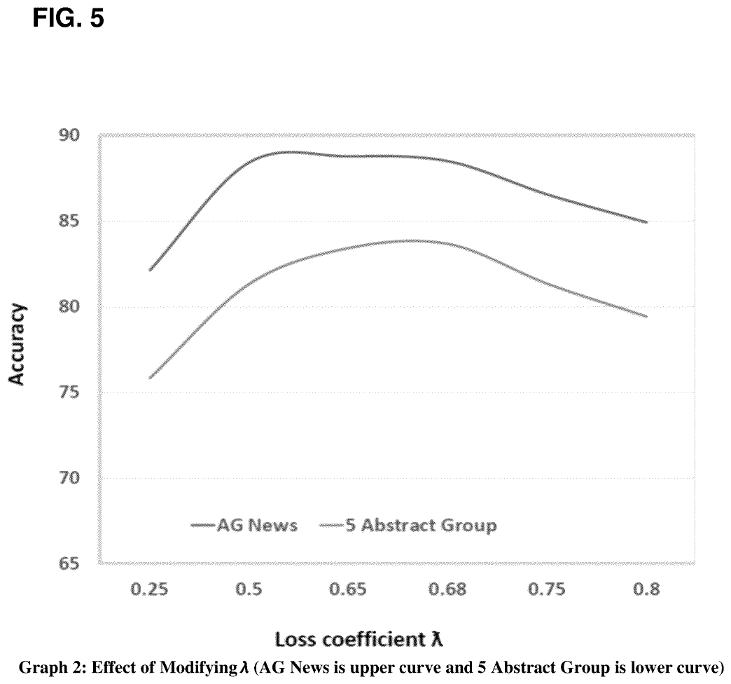

Importance of Intermediate Layers: A sensitivity analysis was conducted by varying λ in the loss function, which is associated with the knowledge from intermediate layers. Graph 2 shown in FIG. 5 presents the effects of different λ values on the AG News and 5 Abstracts Group datasets. In the Graph 2 shown in FIG. 5, the AG News is the upper curve and the 5 Abstract Group is the lower curve. The analysis shows that the model performs best with λ˜0.65, indicating the relatively higher importance of intermediate layers for improving performance. This finding aligns with prior studies, which have observed that Transformer-based models often encode transferable features in their intermediate layers.

Usability & Visibility of Invention The results and innovations presented in this disclosure hold considerable promise for the field of natural language processing, particularly in scenarios where accessing original training data for teacher models proves to be a challenge. STRATANET fills a critical gap by enabling the amalgamation of knowledge from multiple teachers, each with their own domain-specific expertise, even when their training data is inaccessible. This achievement is especially crucial in applications where insights from diverse areas are required, such as in multi-domain sentiment analysis, cross-disciplinary research, or applications involving proprietary data. For example, in a medical context, where sensitive patient information is involved, accessing original training data for large language models might be ethically or legally restricted. STRATANET steps in as a powerful alternative, allowing knowledge transfer from teachers specializing in healthcare without compromising privacy.

The versatility of the student models trained using the STRATANET approach makes the embodiments of the present disclosure applicable to a wide array of domains. Whether in healthcare, legal, finance, customer service, or any other field, the framework can be tailored to amalgamate specialized knowledge from experts in those respective domains. Furthermore, STRATANET enables the training of lightweight student models, which are computationally less demanding compared to larger teacher models. The student model that is trained in at least some embodiments is smaller than one, some, or all of the teacher models, e.g., includes fewer layers and/or fewer parameters than the respective teacher model includes. This reduction in size and computation requirements means that organizations can achieve high-performing models without the need for extensive computational resources. Given its focus on natural language processing (NLP), STRATANET is particularly useful for natural language processing applications. It can enhance tasks like sentiment analysis, text classification, language translation, and content generation across various domains. For example, specialized teachers trained on different language pairs or specific domains can contribute to a multilingual translation model. STRATANET can amalgamate their knowledge to create a model capable of accurately translating and understanding various languages and domains.

By amalgamating the expertise of multiple teachers, each focused on a specific domain, STRATANET can empower large language models to become versatile and adept in a broader range of applications. This enhancement is especially pertinent in industries like healthcare, legal, or finance, where domain-specific knowledge is critical. Furthermore, STRATANET Specialized teachers trained on different language pairs or specific domains can contribute to a multilingual translation model. STRATANET can amalgamate their knowledge to create a model capable of accurately translating and understanding various languages and domains.

In terms of the visibility of the present embodiments, STRATANET distinguishes itself by being explicitly designed for scenarios involving multiple heterogeneous teachers without access to their training data. These features makes STRATANET particularly relevant for industries and applications where data privacy, security, or intellectual property concerns are paramount.

It may be appreciated that FIGS. 1-3 provide only illustrations of certain embodiments and do not imply any limitations with regard to how different embodiments may be implemented. Many modifications to the depicted embodiment(s), e.g., to particular steps, elements, and/or order of depicted methods or components of the pipeline, may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

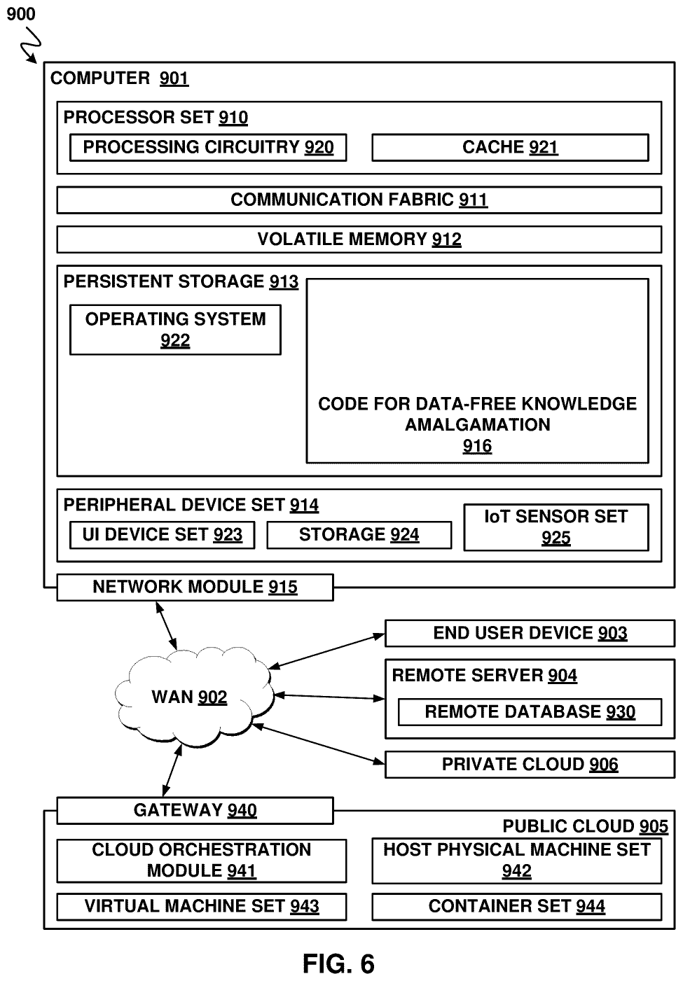

Computing environment 900 in FIG. 6 contains an example of an environment for the execution of at least some of the computer code involved in performing the inventive methods, such as code for data-free knowledge amalgamation 916. In addition to code for data-free knowledge amalgamation 916, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and code for data-free knowledge amalgamation 916, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in code for data-free knowledge amalgamation 916 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in model-generated code evaluation with code for data-free knowledge amalgamation 916 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing exceptionally large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901) and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The computer 901 in some embodiments also hosts one or more machine learning models such as a transformer or other portions of the code for data-free knowledge amalgamation for text classification 916. A machine learning model in one embodiment is stored in the persistent storage 913 of the computer 901. A received data sample is input to the machine learning model via an intra-computer transmission within the computer 901, e.g., via the communication fabric 911, to a different memory region hosting the machine learning model.

In some embodiments, one or more machine learning models are stored in computer memory of a computer positioned remotely from the computer 901, e.g., in a remote server 904 or in an end user device 903. In this embodiment, the code 916 works remotely with this machine learning model to access same. Prompts are sent via a transmission that starts from the computer 901, passes through the WAN 902, and ends at the destination computer that hosts the machine learning model. Thus, in some embodiments the code 916 at the computer 901 or another instance of the software at a central remote server performs routing of machine learning input to multiple server/geographical locations in a distributed system.

In such embodiments, a remote machine learning model is configured to send its output back to the computer 901 so that information related to knowledge amalgamation output from using a model and/or other code is provided and presented to a user. The model receives a copy of the input, performs actions on the received input, and transmits the results, e.g., an output back to the computer 901.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods, and computer program products according to various embodiments. In this regard, each block in the flowchart, pipeline, and/or block diagrams may represent a module, segment, or portion of instructions, which comprises one or more executable instructions for implementing the specified logical function(s).

What is claimed is:

1. A computer-implemented method comprising:
obtaining multiple pre-trained teacher machine learning models, each trained on a respective different set of training data;
generating pseudo-data samples that mimic the respective training data of the teacher models; and
implementing a block-wise amalgamation with a self-regulative strategy to integrate knowledge from the multiple teacher models by inputting the pseudo-data samples into the teacher models and into a student machine learning model, wherein the implementing comprises aligning intermediate representations of the student model with a unified representation capturing relevant features from the teacher models.

2. The method of claim 1, wherein the student model is trained by optimizing its parameters to enhance its performance, based on comparing probability distributions of predictions made by the teacher models to probability distributions of predictions made by the student model for the pseudo-data samples.

3. The method of claim 2, wherein the optimizing comprises a minimization of a combined loss comprising a block-wise knowledge transfer loss and KL-divergence between the predictions of the teacher models and of the student model for the pseudo-data samples.

4. The method of claim 3, wherein the block-wise knowledge transfer loss is calculated as an L2-normalized distance between a projected block-level representation of the student model and a corresponding amalgamated embedding of the teacher models.

5. The method of claim 1, wherein the pseudo-data samples are generated respectively per class of the pre-trained teacher models.

6. The method of claim 1, wherein a teacher-specific steerable data generator produces the pseudo-data samples via:
(a) using an autoregressive unconditional pre-trained language model (PLM) to generate class or attribute conditional text relevant to a label set of a respective one of the teacher models; and
(b) implementing a weighted decoding mechanism that guides the PLM, under influence of the respective one of the teacher models, towards a specific class or attribute of interest.

7. The method of claim 6, wherein the generation of the class or attribute conditional text is begun by inputting a generic start token or a class-descriptive prompt into the PLM and comprises iterative next word prediction in response to an input of previously generated tokens.

8. The method of claim 6, wherein one or more sampling strategies are applied to generate the class or attribute conditional text from an output distribution of the PLM.

9. The method of claim 8, wherein the one or more sampling strategies comprise at least one of top-k sampling and nucleus sampling.

10. The method of claim 1, wherein the block-wise amalgamation comprises:
estimating an out-of-distribution (OOD) score to measure a respective confidence of the teacher models across different intermediate layers when the teacher models make predictions on input text; and
employing a block-wise integration with a selective transformer to self-regulate knowledge from the teacher models based on the OOD scores.

11. The method of claim 10, wherein the block-wise integration comprises producing the unified representation by assigning a respective weight for a respective representation at a block level of a particular teacher model corresponding to a confidence level of the OOD score of the particular teacher model.

12. The method of claim 10, wherein the block-wise integration handles a varying number of layers between the teacher models and the student model by performing mean pooling over layer representations within blocks of the teacher models.

13. The method of claim 1, wherein the student model is respectively smaller than each of the teacher models.

14. A computer system comprising:
a processor set;
a set of one or more computer-readable storage media; and
program instructions, collectively stored on the set of one or more storage media, for execution by the processor set to cause computer operations comprising:
obtaining multiple pre-trained teacher machine learning models, each trained on a respective different set of training data;
generating pseudo-data samples that mimic the respective training data of the teacher models; and
implementing a block-wise amalgamation with a self-regulative strategy to integrate knowledge from the multiple teacher models by inputting the pseudo-data samples into the teacher models and into a student machine learning model, wherein the implementing comprises aligning intermediate representations of the student model with a unified representation capturing relevant features from the teacher models.

15. The computer system of claim 14, wherein the student model is trained by optimizing its parameters to enhance its performance, based on comparing probability distributions of predictions made by the teacher models to probability distributions of predictions made by the student model for the pseudo-data samples.

16. The computer system of claim 15, wherein the optimizing comprises a minimization of a combined loss comprising a block-wise knowledge transfer loss and a KL-divergence between the predictions of the teacher models and of the student model for the pseudo-data samples.

17. The computer system of claim 16, wherein the block-wise knowledge transfer loss is calculated as an L2-normalized distance between a projected block-level representation of the student model and a corresponding amalgamated embedding of the teacher models.

18. A computer program product comprising:
a set of one or more computer-readable storage media; and
program instructions, collectively stored on the set of one or more storage media, for execution by a processor set to cause computer operations to be performed comprising:
obtaining multiple pre-trained teacher machine learning models, each trained on a respective different set of training data;
generating pseudo-data samples that mimic the respective training data of the teacher models; and
implementing a block-wise amalgamation with a self-regulative strategy to integrate knowledge from the multiple teacher models by inputting the pseudo-data samples into the teacher models and into a student machine learning model, wherein the implementing comprises aligning intermediate representations of the student model with a unified representation capturing relevant features from the teacher models.

19. The computer program product of claim 18, wherein a teacher-specific steerable data generator produces the pseudo-data samples via:
(a) using an autoregressive unconditional pre-trained language model (PLM) to generate class or attribute conditional text relevant to a label set of a respective one of the teacher models; and
(b) implementing a weighted decoding mechanism that guides the PLM, under influence of the respective one of the teacher models, towards a specific class or attribute of interest.

20. The computer program product of claim 19, wherein the generation of the class or attribute conditional text is begun by inputting a generic start token or a class-descriptive prompt into the PLM and comprises iterative next word prediction in response to an input of previously generated tokens.
